(19) United States
(12) Patent Application Publication
(10) Pub. No.: US 2016/0094058 A1
(43) Pub. Date: Mar. 31, 2016

(54) EXTERNAL BATTERY APPARATUS AND CONTROL METHOD THEREOF

(71) Applicant: SAMSUNG SDI CO., LTD., Yongin-si (KR)

(72) Inventor: Jong-Chan HAN, Yongin-si (KR)

(21) Appl. No.: 14/796,317

(22) Filed: Jul. 10, 2015

(30) Foreign Application Priority Data
Sep. 29, 2014 (KR) 10-2014-0130163

(51) Int. Cl. H02J 7/00

(52) U.S. Cl. CPC H02J 7/007; H02J 7/0021; H02J 7/0045

(57) ABSTRACT

An external battery apparatus includes at least one battery cell; a circuit device to increase a voltage of the battery cell to a predetermined voltage level and to output the increased voltage level; a cell voltage measurer configured to measure the voltage of the battery cell; and a controller configured to compare the measured voltage of the battery cell with a predetermined reference value, and to control the circuit device such that a charging current having a different level is output corresponding to a result of the comparison.

### CROSS-REFERENCE TO RELATED APPLICATION

Korean Patent Application No. 10-2014-0130163, filed on Sep. 29, 2014, in the Korean Intellectual Property Office, and entitled: “External Battery Apparatus and Control Method Thereof,” is incorporated by reference herein in its entirety.

### BACKGROUND

1. Field

Various embodiments of the present disclosure relate to a battery and, more particularly, to an external battery apparatus and a control method thereof.

2. Description of the Related Art

Most wireless and portable devices, such as mobile telephones, receive power from batteries. As these portable devices become more and more miniaturized and lighter, the performance of batteries that supply power to these device are continuously being improved as well. Lithium (Li)-ion batteries are in general use these days for numerous applications, as they have energy densities several times higher than other batteries.

Furthermore, the aforementioned portable devices are widely used in outdoor environments where power cannot be supplied directly, and thus there is a difficulty that when a battery inside a portable device is used up when using the device outside, the user has to find a place where power can be supplied and charge the battery in the portable device using an alternating current (AC) adapter or a universal serial bus (USB) connector.

Therefore, if the user wishes to use the portable device continuously in an outdoor environment or otherwise away from an electrical outlet, there is a need to use an external battery to charge the battery that is inside the portable device. Thus, various external battery apparatuses have been developed that are capable of charging a battery inside a portable device at emergency situations without having to depend on the battery inside the portable device.

### SUMMARY

According to an embodiment of the present disclosure, there is provided an external battery apparatus including at least one battery cell; a DC-DC converter configured to increase a voltage of the battery cell to a predetermined voltage level and to output the increased voltage level; a cell voltage measurer configured to measure the voltage of the battery cell; and a controller configured to compare the measured voltage of the battery cell with a predetermined reference value, and to control such that a charging current having a different level is output corresponding thereto.

The predetermined reference value may be a voltage value corresponding to 80% of a maximum voltage of the battery cell.

In response to the measured voltage of the battery cell being or above the reference value, the external battery apparatus may perceive an adaptor charge mode, and output a charging current corresponding thereto, and the charging current corresponding to the adaptor charge mode may be 1 to 2 A.

In response to the measured voltage of the battery cell being below the reference value, the external battery apparatus may perceive a USB charge mode, and output a charging current corresponding thereto, and the charging current corresponding to the USB charge mode may be about 500 mA.

According to an embodiment of the present disclosure, there is provided a method for controlling an external battery apparatus, the method including connecting the external battery apparatus with a portable device where an internal battery is mounted, through a USB cable; measuring a voltage of a battery cell inside the external battery apparatus changed by discharging of the battery cell; comparing the measured voltage of the battery cell with a predetermined reference value; and comparing the measured voltage of the battery cell with the predetermined reference value, and providing a charging current having a different level to the internal battery mounted onto the portable device, thereby charging the internal battery.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram of a configuration of an external battery apparatus according to an embodiment of the present disclosure;

FIG. 2 illustrates a graph of a relationship between a voltage of a battery cell and a temperature generated when a charged current of an external battery apparatus is discharged to 1 A;

FIG. 3 illustrates a view of a state of connection between the external battery apparatus of FIG. 1 and a portable device; and

FIG. 4 illustrates a flowchart of a method for controlling an external battery apparatus according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

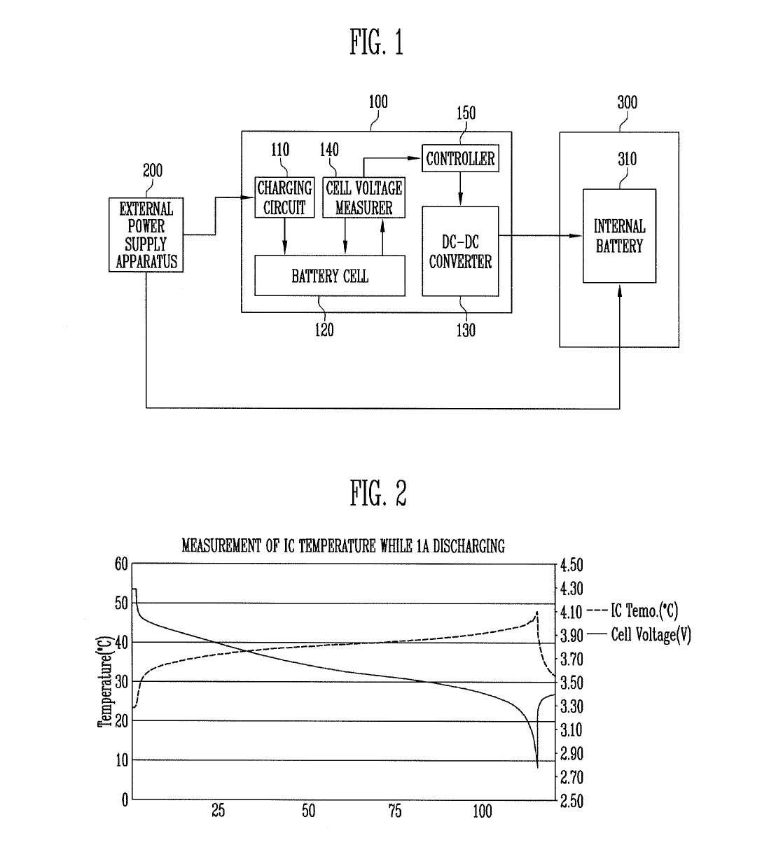

FIG. 1 is a block diagram illustrating a configuration of an external battery apparatus 100 according to an embodiment of the present disclosure. Referring to FIG. 1, the external battery apparatus 100 includes a charging circuit 110, battery cell 120, DC-DC converter 130, cell voltage measurer 140, and controller 150.

The charging circuit 110 converts a voltage provided from an external power supply apparatus 200 into a voltage (buffer voltage) appropriate for charging the battery cell 120 inside the external battery apparatus 100, and then charges the battery cell 120 using the converted voltage.

The external power supply apparatus 200 is an apparatus for receiving power from outside and charging the external battery apparatus 100 or an internal battery 310 mounted onto a portable device 300. The external power supply apparatus 200 provides direct current power necessary to charge the external battery apparatus 100 and/or internal battery 310.

Herein, the external power supply apparatus 200 may be embodied as an AC adapter or a USB connector. When an AC adapter, the external power supply apparatus 200 provides about 1 A of charging current. When a USB connector, the external power supply apparatus 200 provides about 500 mA of charging current.

The charging circuit 110 is an apparatus that operates when the external battery apparatus 100 is connected to the external power supply apparatus 200 and is being charged. The charging circuit 110 does not operate when the external battery apparatus 100 is being discharged.

That is, the external battery apparatus 100 may play a role of charging the internal battery 310 mounted onto the portable device 300 through the aforementioned discharging operation, in which case the external battery apparatus 100 may operate in the same manner as the external power supply apparatus 200.

However, in order to charge the internal battery 310 using the external battery apparatus 100, an output voltage of the external battery apparatus 100 must be increased to a predetermined voltage level (for example 5V). This increasing of output voltage is performed through the DC-DC converter 130.

When the discharging operation of the external battery apparatus 100 is performed as aforementioned, a voltage of the battery cell 120 provided inside the external battery apparatus 100 changes continuously, wherein its efficiency differs according to the changes of the cell voltage. That is, the lower the cell voltage, the lower the efficiency, thereby intensifying generation of heat in a circuit device inside the external battery apparatus 100.

Specifically, as aforementioned, the output voltage must be increased to 5V in order to charge the internal battery 310. However, when the cell voltage decreases, the DC-DC converter 130 that plays the role of increasing the voltage will be overloaded thereby generating heat.

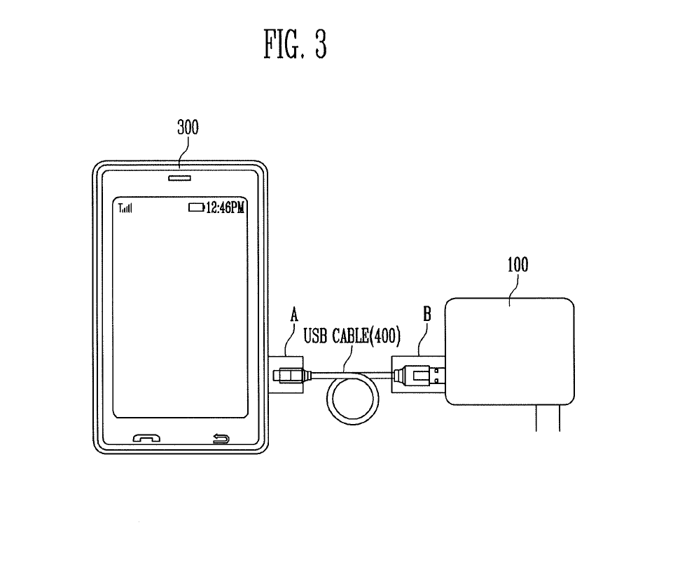

FIG. 2 is a graph illustrating a relationship between a voltage of a battery cell and a temperature of heat generated when a charged current of an external battery apparatus is discharged to 1 A.

Referring to FIG. 2, when the battery cell 120 of the external battery apparatus 100 is completely charged by the external power supply apparatus 200, it may have a voltage level of about 4.3V to 4.5V. That is, the maximum voltage value of the battery cell 120 is about 4.3V to 4.5V.

When the external battery apparatus 100 is completely charged and then a discharging operation is performed, i.e., when the external battery apparatus 100 is connected to the portable device 300 and performs an operation of charging the internal battery 310 mounted onto the portable device 300, a voltage of the battery cell 120 inside the external battery apparatus 100 gradually decreases, as illustrated in FIG. 2.

However, the temperature in circuit devices inside the external battery apparatus 100 (for example, DC-DC converter 130) may gradually increase when the DC-DC converter 130, which increases the voltage to 5V as the cell voltage decreases, is overloaded.

Using a DC-DC converter 130 having a higher current specification in order to overcome the aforementioned problem would increase cost. If the external battery apparatus 100 is designed to stop the discharging in response to the cell voltage decreasing below a predetermined level, there would be a disadvantage of not being able to sufficiently use the capacity of the battery cell 120 inside the external battery apparatus 100.

Thus, in order to overcome these disadvantages, the present embodiment of the present disclosure measures the voltage of the battery cell 120 inside the external battery apparatus 100 and outputs a charging current of a different level predetermined according to a value of the cell voltage, thereby preventing the circuit device (DC-DC converter 130) of the external battery apparatus 100 from being overheated.

That is, the cell voltage measurer 140 measures the voltage of the battery cell 120, and delivers the measured cell voltage to the controller 150. Herein, measuring the cell voltage may be performed in real time.

The controller 150 controls the DC-DC converter 130 such that the charging current when the external battery apparatus 100 is discharged, i.e., when the internal battery 310 is charged may be output as a different predetermined level based on the cell voltage value measured by the cell voltage measurer 140.

When the external battery apparatus 100 charges the portable device 300 where the internal battery 310 is mounted in the same manner as the external power supply apparatus 200, the portable device 300 perceives the external battery apparatus 100 as an AC adapter or a USB connector. That is, charging the battery may be differentiated as an adapter charging mode or an USB charging mode.

When an AC adapter (adapter charging mode) is determined, 1 to 2 A may be output as the charging current of the battery. When a USB connector (USB charging mode) is determined, about 500 mA may be output as a charging current of the battery.

Therefore, in an embodiment of the present disclosure, when a level of the cell voltage is determined to be at or above a reference value based on a cell voltage value measured by the cell voltage measurer 140, an adapter charging mode would be perceived, and a charging current output from the external battery apparatus 100 would be about 1 A. On the other hand, when the level of the cell voltage is determined to be below the reference value based on the cell voltage value measured by the cell voltage measurer 140, a USB charging mode would be perceived, and a charging current output from the external battery apparatus 100 would be about 500 mA.

Herein, the reference value may be set differently depending on the temperature of a circuit device of the external battery apparatus 100.

In a case of the example illustrated in FIG. 2, the voltage of the battery cell 120 is about 3.5V when the temperature of the circuit device is about 40 degrees, and thus the reference value may be set to 3.5V. In particular, assuming that the maximum voltage of the battery cell 120 is 4.5V, 3.5V is about 80% of the maximum voltage. Thus, the reference value may be set to 80% of the maximum voltage of the battery cell 120. Of course, other percentages of the maximum voltage may be used for the reference value as appropriate.

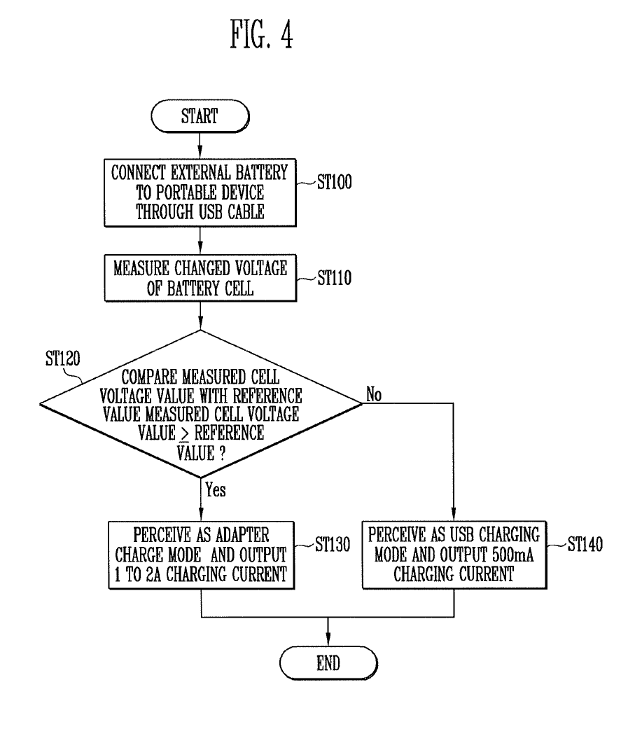

FIG. 3 is a view illustrating a state of connection between the external battery apparatus of FIG. 1 and a portable device. As illustrated in FIG. 3, the external battery apparatus 100 is connected to the portable device 300 using a USB cable 400.

An embodiment of the present disclosure is configured to measure a voltage of the battery cell 120 provided in the external battery apparatus 100, differentiate the external battery apparatus 100 as an adapter charging mode or USB charging mode by the measured voltage value, and provide a charging current corresponding to each charging mode to the internal battery 310 mounted onto the portable device 300 through the USB cable 400, thereby charging the internal battery 310.

Receptacle A of the portable device 300 may include a Vbus, D−, D+, ID, and Ground pin. The portable device 300 is connected to the battery apparatus 100 through a USB cable 400 where plug A and plug B are attached to each side thereof. In this case, plug A of the USB cable is connected to Receptable A of the portable device 300, and plug B is connected to Receptable B of the external battery apparatus 100.

Furthermore, plug A may include a Vbus, D−, D+, ID, and Ground pin corresponding to Receptable A. Furthermore, plug B and Receptacle B may include a Vbus, D−, D+, and Ground pin, respectively.

In an embodiment of the present disclosure, adjusting a pin state of D− and D+ of Receptacle B of the external battery apparatus 100 may be used to set the charging mode.

For example, when the voltage of the battery cell 120 is at or above the reference value, the pin state of D− and D+ of Receptacle B may be set to an adapter charging mode so that 1 to 2 A charging current may be output. When the voltage of the battery cell is below the reference value, which may result in the temperature of the circuit device of the external battery apparatus increasing, the pin state of D− and D+ of Receptacle B may be set to a USB charging mode, so that the charging mode may be decreased from 1 to 2 A to 500 mA, thereby preventing the circuit device inside the external battery apparatus 100 from being overheated.

In another example, it is possible to configure a current restricting integrated circuit (IC) in an output terminal of the external battery apparatus 100, so as to change the current restriction value from 1 to 2 A to 500 mA when the voltage of the battery cell 120 is below the reference value.

FIG. 4 is a flowchart of a method for controlling an external battery apparatus according to an embodiment of the present disclosure.

First of all, the external battery apparatus is connected to the portable device to which the internal battery is mounted, e.g., through the USB cable (ST 100).

As the battery cell inside the external battery apparatus is discharged, a predetermined charging current is provided to the internal battery of the portable device, thereby charging the internal battery.

Then, the voltage of the battery cell changed by the discharging of the battery cell is measured (ST 110). Herein, measuring the cell voltage may be performed in real time.

Then, the measured cell voltage value is compared with the predetermined reference value (ST 120).

Herein, the reference value may be set differently for each apparatus according to the temperature of a circuit device of the external battery apparatus.

In the case of the example illustrated in FIG. 2, the voltage of the battery cell is about 3.5V when the temperature of the circuit device is about 40 degrees, and thus the reference value may be set to 3.5V.

Herein, given the maximum value of the battery cell is 4.5V, 3.5V is about 80% of the maximum voltage, and thus the maximum voltage of the battery cell may be set to 80%.

When the measured cell voltage is or above the reference value, an adapter charging mode is perceived, and the charging current is set to 1 to 2 A (ST 130). When the level of the cell voltage is below the reference value, a USB charging mode is perceived, and the charging current is set to about 500 mA, and then output (ST 140).

That is, an embodiment of the present disclosure measures the voltage of the battery cell provided inside the external battery, differentiates the external battery apparatus as an adapter charging mode or USB charging mode by the measured voltage value, and provides a charging current corresponding to each charging mode to the internal battery mounted onto the portable device through the USB cable, thereby preventing the circuit device inside the external battery apparatus from being overheated through discharging of the internal battery.

In other words, according to one or more embodiments, an external battery apparatus measures a voltage of a battery cell inside the external battery apparatus and outputs a charging current having a different level predetermined according to a size of the cell voltage, thereby preventing an internal device of the external battery apparatus from being overheated, and a control method thereof.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An external battery apparatus, comprising:
at least one battery cell;
a circuit device to increase a voltage of the battery cell to a predetermined voltage level and to output the increased voltage level;
a cell voltage measurer to measure the voltage of the battery cell; and
a controller to compare the measured voltage of the battery cell with a predetermined reference value, and to control the circuit device such that a charging current having a different level is output in accordance with a result of the comparison.

2. The external battery apparatus as claimed in claim 1,
wherein the predetermined reference value is a voltage value corresponding to 80% of a maximum voltage of the battery cell.

3. The external battery apparatus as claimed in claim 1, wherein, when the measured voltage of the battery cell is equal to or greater than the predetermined reference value, the controller determines an adaptor charge mode, and the circuit device outputs a charging current corresponding thereto.

4. The external battery apparatus as claimed in claim 3, wherein the charging current of the adaptor charge mode is 1 to 2 A.

5. The external battery apparatus as claimed in claim 1, wherein, when the measured voltage of the battery cell is less than the predetermined reference value, the controller determines a USB charge mode, and the circuit device outputs a charging current corresponding thereto.

6. The external battery apparatus as claimed in claim 5, wherein the charging current of the USB charge mode is about 500 mA.

7. The external battery apparatus as claimed in claim 1, wherein the circuit device includes a DC-DC converter.

8. A method for controlling an external battery apparatus, the method comprising:
connecting the external battery apparatus with a portable device where an internal battery is mounted;
measuring a voltage of a battery cell inside the external battery apparatus changed by discharging of the battery cell;
comparing the measured voltage of the battery cell with a predetermined reference value; and
providing a charging current having a different level to the internal battery mounted onto the portable device in accordance with the comparing, thereby charging the internal battery.

9. The method as claimed in claim 8, when comparing determines that the measured voltage of the battery cell is equal to or greater than the predetermined reference value, determining an adaptor discharge mode.

10. The method as claimed in claim 9, wherein the charging current is 1 to 2 A in the adaptor discharge mode.

11. The method as claimed in claim 8, when comparing determines that the measured cell voltage is below the predetermined reference value, determining a USB charge mode.

12. The method as claimed in claim 11, wherein the charging current is about 500 mA in the USB charge mode.

13. The method as claimed in claim 8, wherein connecting the external battery apparatus and the portable device includes using a USB cable.
